(19) United States
(12) Patent Application Publication
(10) Pub. No.: US 2013/0191726 A1
(43) Pub. Date: Jul. 25, 2013

(54) AUTOMATIC WIDGET CREATION APPARATUS AND METHOD FOR INVOKING HETEROGENEOUS WEB SERVICES IN A COMPOSITE APPLICATION

(71) Applicant: Electronics and Telecommunications Research, Daejeon-si (KR)

(72) Inventors: Yoo-Mi PARK, Daejeon-si (KR); Cin-Young HUR, Seoul (KR)

(73) Assignee: Electronics and Telecommunications Research Institute, Daejeon-si (KR)

(21) Appl. No.: 13/679,217

(22) Filed: Nov. 16, 2012

(30) Foreign Application Priority Data
Jan. 20, 2012 (KR) 10-2012-0006973

(51) Int. Cl. G06F 17/00

(52) U.S. Cl. 715/235; 715/234

(57) ABSTRACT

An apparatus and method for providing a development environment of a heterogeneous web service composite application are provided. The apparatus searches and combines multiple heterogeneous web services to make composite application, generates an executable code of the composite application, and generates and renders the executable code on any web browser to execute the composite application.

### CROSS-REFERENCE TO RELATED APPLICATION

s This application claims the benefit under 35 U.S.C. §119(a) of Korean Patent Application No. 10-2012-0006973, filed on Jan. 20, 2012, the entire disclosure of which is incorporated herein by reference for all purposes.

### BACKGROUND

1. Field

The following description relates to application software technology, and more particularly, to technology for composing web services.

2. Description of the Related Art

As simple object access (SOA)-based web services are open on the Web and the number of web services increases greatly, the web services are considered as the core resource of service composition or mashup technology. However, web service technology is being realized in various types, for example, a simple object access protocol (SOAP)-based service and a RESTful service, etc. Therefore, in developing a new service by composing the web services independent of web service types, there may arise serious problems with, for example, authentication, authorization, same origin policy, execution environment, etc.

Particularly, invocation of a web service needs to encode and decode with the protocol that supports to deliver the web service, to authenticate a user of the web service, and to comply with a programming rule dependent of the execution environment. Also, when an execution environment has been changed, the existing code cannot be reused. Therefore, developing composite application with web services takes much time and manual efforts for developers even experts. Business process execution language for web services (BPEL-WS) is one of typical standard web service composition languages. It is widely used to make application by composing homogeneous (mainly, SOAP-based) web services in an enterprise domain. However, it needs BPEL engine as an execution environment to run BPEL executable code.

U.S. Patent Publication No. 20100162274 discloses technology that creates a general web application with a desktop widget. U.S. Patent Publication No. 20090172567 discloses technology that dynamically adds a navigation widget for the loose integration of multiple web pages. Korean Patent Publication No. 2011-0060419 discloses technology that creates a JavaScript code for implementing a web-based user interface (UI).

### SUMMARY

The following description relates to an apparatus and method for providing a development environment of a heterogeneous web service composite application, which enable a web service to automatically execute a combined application freely irrespective of a device and a platform.

In one general aspect, an apparatus for providing a composite application development environment includes: a web service composition module configured to search and combine multiple web services configuring a heterogeneous web service composite application; an executable code creation module configured to create an executable code for executing the composite application; and a composite application execution module configured to render the created executable code on a web browser to execute the composite application.

In another general aspect, a method for providing a composite application development environment includes: searching and composing multiple web services configuring a composite application; creating an executable code for executing the composite application; and rendering the created executable code on a web browser to execute the composite application.

In another general aspect, a method for providing a composite application development environment includes: providing a search window which enables an application developer to search multiple web services, and an editing window for composing the searched web services to develop a composite application; providing a JavaScript-based widget for each of the web services using a web browser for invoking a web service, after searching and editing the web services; and providing a user interface for executing the composite application on the web browser with the provided widget, the user interface including an access code acquisition function, a web service invocation function, and an invocation cancelation function.

Other features and aspects will be apparent from the following detailed description, the drawings, and the claims.

### BRIEF DESCRIPTION OF THE DRAWINGS

FIG. 1 is a reference diagram for describing an automatic creation concept of executable code of a composite application for invoking web services in a development environment of a heterogeneous web service composite application to which the present invention is applied.

FIG. 2 is a block diagram illustrating an apparatus for providing a development environment of a heterogeneous web service composite application according to an embodiment of the present invention.

FIG. 3 is an exemplary diagram illustrating a graphic user interface (GUI) which is provided by the apparatus for providing the development environment of the heterogeneous web service composite application according to an embodiment of the present invention.

FIG. 4 is a block diagram of a widget including executable codes by heterogeneous web service according to an embodiment of the present invention, and is a reference diagram illustrating a function of the widget.

FIG. 5 is a flowchart illustrating a method of providing a development environment of a heterogeneous web service composite application according to an embodiment of the present invention.

FIGS. 6A and 6B are flowcharts illustrating in detail the method of providing the development environment of the heterogeneous web service composite application according to an embodiment of the present invention.

FIGS. 7A to 7C are flowcharts illustrating in detail a process of creating an executable code and executing a heterogeneous web service composite application according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, exemplary embodiments of the present invention will be described in detail. In the drawings, the sizes or shapes of elements may be exaggerated for clarity and convenience of description. Moreover, the terms used henceforth have been defined in consideration of the functions of the present invention, and may be altered according to the intent of a user or operator, or conventional practice. Therefore, the terms should be defined on the basis of the entire content of this specification.

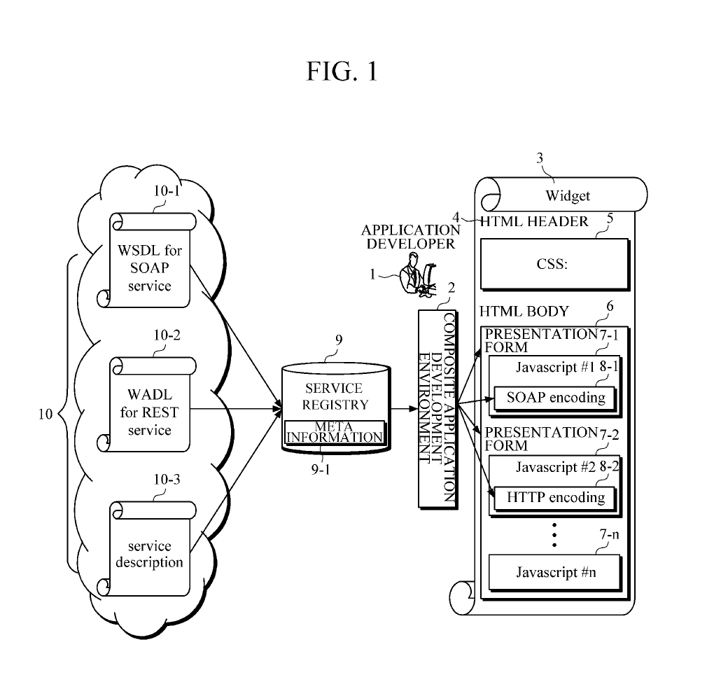

FIG. 1 is a reference diagram for describing an automatic creation concept of executable code of a composite application for invoking web services in a development environment 2 of a heterogeneous web service composite application to which the present invention is applied.

An application developer 1 (hereinafter referred to as a developer 1) is a software developer that composes web services to develop a new composite application. Although the developer 1 is not an expert skilled in programming languages or web services, the present invention enables the developer 1 to easily develop a web service composite application regardless of a device or a platform, thus saving the development cost such as an application development procedure and time. The composite application development environment 2 automatically creates a JavaScript-based composite application executable code on a web browser in real time to invoke heterogeneous web services that configure a composite application. The composite application development environment 2 is a system which the present invention proposes, and is used together with an apparatus for providing a composite application development environment.

A widget 3 is an executable code type of a composite application that the developer 1 may create in the composite application development environment 2. The widget 3 may be configured with HTML, cascading style sheet (CSS), and JavaScript. An HTML header/body 4 configures a frame of the widget 3. A CSS 5 is a form for determining the style of the widget 3. A presentation form 6 is an HTML body that represents an input/output (I/O), access code and the like of a web service 10 in the widget 3. JavaScripts 7-1 to 7-n are parts that include respective invocation codes according to web services. Here, an SOAP encoding 8-1 of the JavaScript #1 7-1 is a part that encodes a message in an SOAP type to actually invoke a web service when the invoked web service is an SOAP-based web service. An SOAP encoding 8-2 of the JavaScript #2 7-2 is a part that encodes a message in an HTTP GET/PUT/POST/DELETE type according to an operation of a web service to actually invoke the web service when the web service is an HTTP-based RESTful web service.

The web service 10 may include a specification for the web service 10. When the web service 10 is an SOAP service, the web service 10 may include a web service description language (WSDL) specification 10-1. In a case in which the web service 10 is a RESTful web service, the web service 10 may include a web application description language (WADL) specification 10-2, or include only a service description webpage 10-3 without including a specification. The present invention is for automatically creating an executable code in a widget type so as to execute a WSDL-based web service or a RESTful web service on a web browser.

A service registry 9 is a storage that stores the specification and additional information of the web service 10 in a meta information type, and is used for the composite application development environment 2 to obtain all information associated with the web service 10. The meta information includes information on a service name, a provider, a service URL, a service description, a service input/output, user evaluation, service availability, a security method, a provision nation, etc.

To summarize the above, in FIG. 1, the developer 1 obtains meta information on an internal or external web service 10 from the service registry 9, creates a composite application with web services composed therein, and automatically creates executable code of a composite application in a widget 3 type, in the composite application development environment 2. Here, the widget 3 is a composite application execution module and may invoke web services on a web browser. Each web service is largely divided into a plurality of form representation parts 5 and 6 and web service invocation parts 7-x and 8-x. The web service invocation parts 7-x and 8-x are SOAP-encoded (see 8-1 in FIG. 1) or HTTP-encoded (see 8-2 in FIG. 1) according to types thereof. An executable code created in the widget 3 type may be executed at all places where a web browser is installed, regardless of a device or a platform.

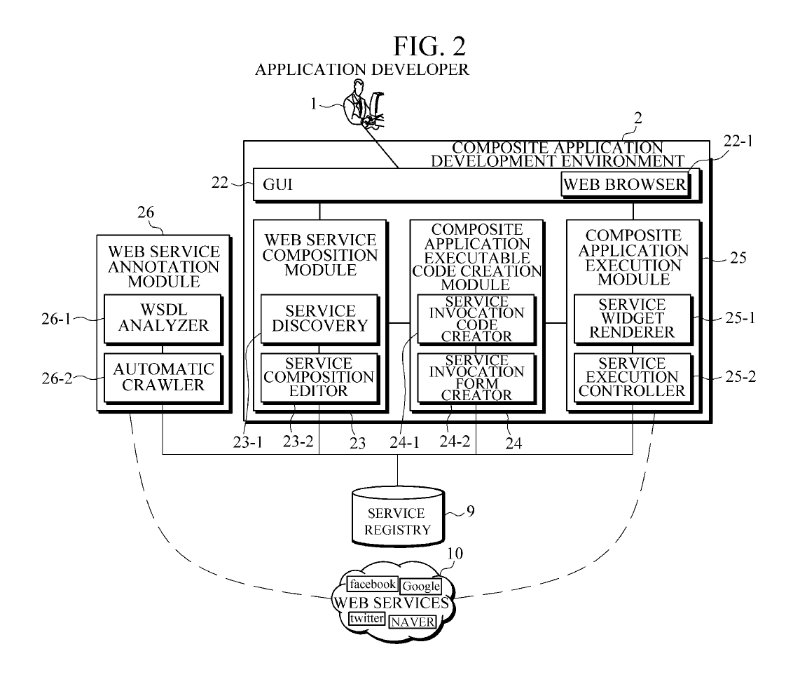

FIG. 2 is a block diagram illustrating an apparatus 2 for providing a development environment of a heterogeneous web service composite application according to an embodiment of the present invention.

Referring to FIG. 2, the apparatus 2 for providing the composite application development environment may include a graphic user interface (GUI) 22, a web service composition module 23, executable code of a composite application creation module 24, and a composite application execution module 25. The apparatus 2 may further include a service registry 9 and a web service annotation module 36.

The GUI 22 is a user interface for interaction between the apparatus 2 for providing the composite application development environment and the developer 1. To this end, the GUI 22 provides a JavaScript-based composite application development environment for invoking a web service in a composite application that is configured with the heterogeneous web services 10. Specifically, the GUI 22 provides an editor, a searcher, and a web browser 22-1.

The web service composition module 23 is a software (SW) module that provides a function that selects and composes web services suitable for the purpose of a composite application that the developer 1 desires to develop, and a search and editing environment. The web service composition module 23 may include a service searcher 23-1 and a service composition editor 23-2. The service searcher 23-1 provides a function that searches web services suitable for the purpose of a composite application from the service registry 9. The service composition editor 23-2 provides an editing function that creates the invocation order and logics of web services that have been searched by the service searcher 23-1.

The composite application executable code creation module 24 is an SW module that creates a JavaScript-based composite application executable code in order for web services to be invoked on a web browser for verifying an application that has been composed by the web service composition module 23. The composite application executable code creation module 24 may include a service invocation code creator 24-1 and a service invocation form creator 24-2. The service invocation code creator 24-1 creates a JavaScript invocation code executable on a web browser according to a web service type such as a WSDL-based SOAP service or a RESTful web service. The service invocation form creator 24-2 provides a function that creates a widget form that can be rendered on a web browser.

The composite application execution module 25 executes a composite application on a web browser, and provides a service execution environment. The composite application execution module 25 may include a service widget renderer 25-1 and a service execution controller 25-2. The service widget renderer 25-1 renders a widget on a web browser, receives a user's input for executing or stopping a service, and provides a function of outputting a result and a function of obtaining an access code. The service execution controller 25-2 encodes a web service invocation request to execute an invocation code. Alternatively, the service execution controller 25-2 receives an output from a web service provider, decodes the received output, and transfers the decoded output to the service widget renderer 25-1.

The web service annotation module 26 is an SW module that automatically extracts meta information from a web service that is installed in a remote server or a local server, and stores the meta information in the service registry 9. Here, the meta information includes information on a service name, a provider, a service URL, a service description, a service input/output, user evaluation, service availability, a security method, a provision nation, etc.

The web service annotation module 26 may include a WSDL analyzer 26-1 and an automatic crawler service composition editor 26-2. When a web service is a WSDL-based web service, the WSDL analyzer 26-1 syntactically analyzes a WSDL service specification to extract meta information. The automatic crawler service composition editor 26-2 crawls a corresponding service webpage for obtaining meta information of the WSDL-based web service or a RESTful web service having no service specification, thereby obtaining the meta information.

The service registry 27 is a storage that stores meta information extracted from a web service specification and additional information. The web service 10 is a software component that is disclosed on the Web through a URL and enables access by the developer 1 through a standard interface.

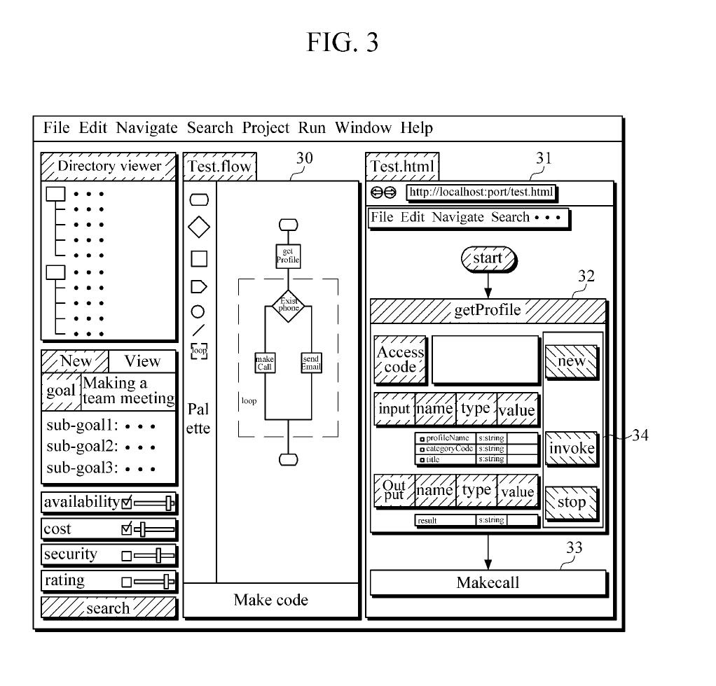

FIG. 3 is an exemplary diagram illustrating a GUI which is provided by the apparatus 2 for providing the development environment of the heterogeneous web service composite application according to an embodiment of the present invention.

The GUI 22 is provided on a web browser. Hereinafter, GUI examples of the web service composition module 23, composite application executable code creation module 24, and composite application execution module 25 will be described.

As a GUI example of the web service composition module 23, as in reference numeral 30, the GUI 22 provides a web service searcher and provides a development environment including an editor and a palette such that the developer 1 searches and composes web services to develop a composite application.

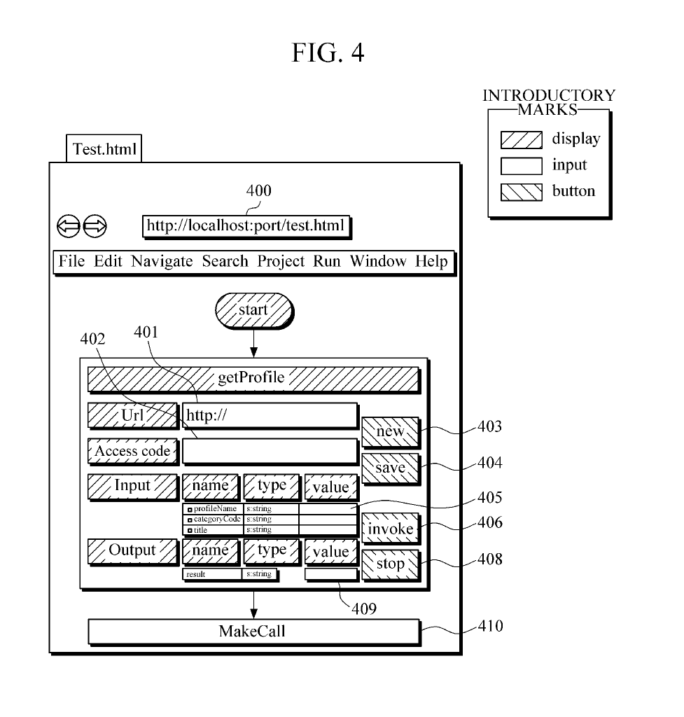

As a GUI example of the composite application executable code creation module 24, as in reference numeral 31, the GUI 22 provides web service widgets 32 and 33 for invoking web services, in order for a composite application to be executed on a web browser. The configuration and function of each of the widgets 32 and 33 will be described below with reference to FIG. 4 in detail.

As a GUI example of the composite application execution module 25, as in reference numeral 34, the GUI 22 provides a function that executes a composite application on a web browser, and an environment thereof. For example, the GUI 22 provides an access code acquisition function, an invocation function, and an invocation cancelation function. The functions will now be described with reference to FIG. 4 in detail.

FIG. 4 is a block diagram of a widget including executable codes by heterogeneous web service according to an embodiment of the present invention, and is a reference diagram illustrating a function of the widget.

When the composite application executable code creation module 24 creates a widget, as illustrated in FIG. 4, the widget is rendered on a web browser. An executable code of a composite application is an HTML document having a URL 400 and configured with web service widgets. Here, the developer 1 may invoke a web service with a widget representing that web service. A URL 401 of the invoked web service (for example, getProfile) is automatically extracted from the service registry 9 and displayed. An access code 402 is an authentication means for the developer 1 accessing a web service. If the developer 1 has obtained the access code 402 in advance, the access code 402 may be automatically displayed on a screen. Otherwise, the developer 1 may click a ‘new’ button 403 to access a webpage of a corresponding web service provider, thereby acquiring the access code 402. Subsequently, the developer 1 may click a ‘save’ button 404 to store the obtained access code 402. The stored access code 402 is automatically extracted when the access code 402 is used later. When the access code 402 has been extracted automatically, although the access code 402 is no longer used for some reason such as expiration of use, the developer 1 may obtain a new access code with the ‘new’ button 403.

Subsequently, the developer 1 personally inputs an input value 405 for invoking a web service and then clicks an ‘invoke’ button 406 to invoke a corresponding web service. At this point, when an output is not obtained before a predetermined timeout value is exceeded, the service widget renderer 25-1 notifies the developer 1 who may click a ‘stop’ button 408 to forcibly end the invocation process. When invocation is normally performed and thus an output is obtained, the output is displayed in a result value window 409. The developer 1 may repeat the above-described scheme for each web service, and thus invoke all web services.

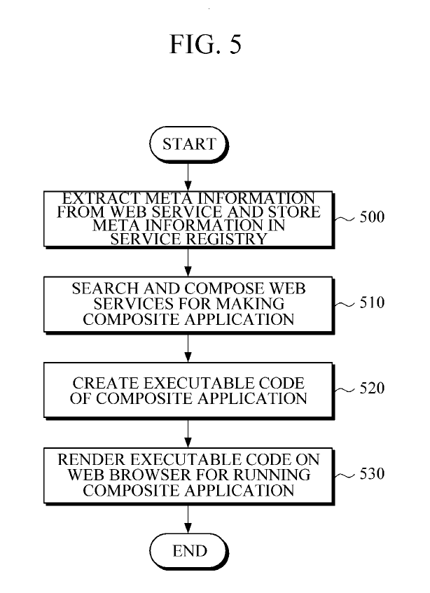

FIG. 5 is a flowchart illustrating a method of providing a development environment of a heterogeneous web service composite application according to an embodiment of the present invention.

An apparatus 1 for providing a composite application development environment searches and combines web services configuring a composite application in operation 510. Subsequently, the apparatus 1 creates an executable code for executing the composite application in operation 520. According to an embodiment, in operation 520 of creating the executable code, the apparatus 1 creates executable code of a composite application having a widget type. The widget is configured with an HTML code for processing the input/output of a web service, a

CSS for determining a form, and a JavaScript for invoking a web service. The apparatus 1 may create different JavaScript-based composite application executable codes per web service so as to be executed on a web browser irrespective of the kind of the web service.

Subsequently, the apparatus 1 for providing the composite application development environment renders the created executable code on a web browser to execute the composite application in operation 530. According to an embodiment, in operation 530 of executing the composite application, the apparatus 1 provides an access code acquisition interface in which the developer 1 may obtain a code for accessing a web service with the executable code of a web browser, an invocation interface in which the developer 1 may input a value necessary for invoking a web service to invoke the web service, and an invocation cancelation interface in which the developer 1 may stop the invoked web service, for web services configuring the composite application.

According to an additional aspect, the method of providing the composite application development environment further includes operation 500 of extracting meta information from the web service specifications and additional information of web services and storing the meta information in the service registry 9. In this case, operation 510 of searching and composing web services may involve searching the web services on the basis of the meta information stored in the service registry 9.

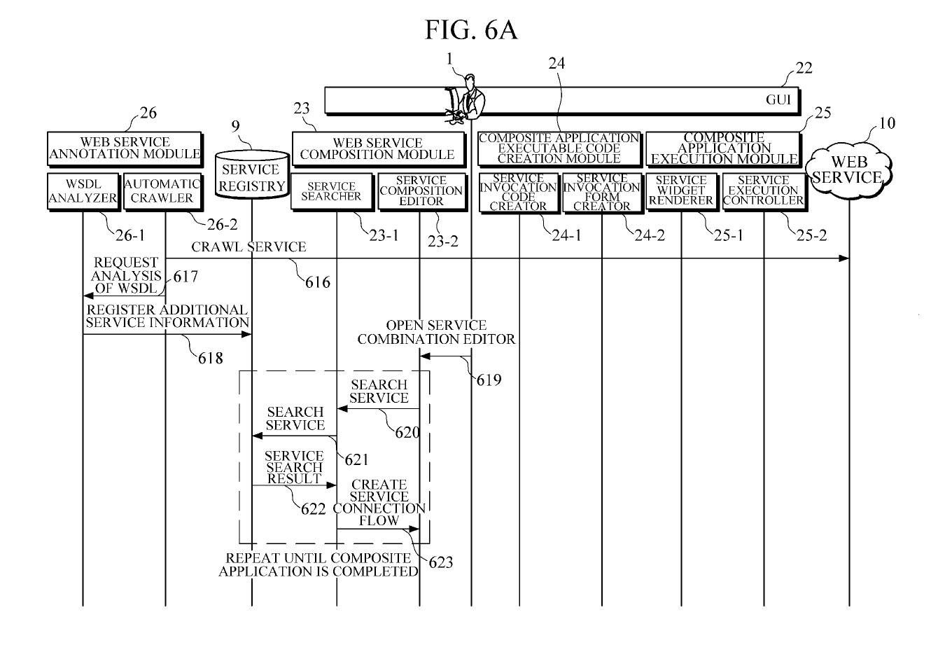

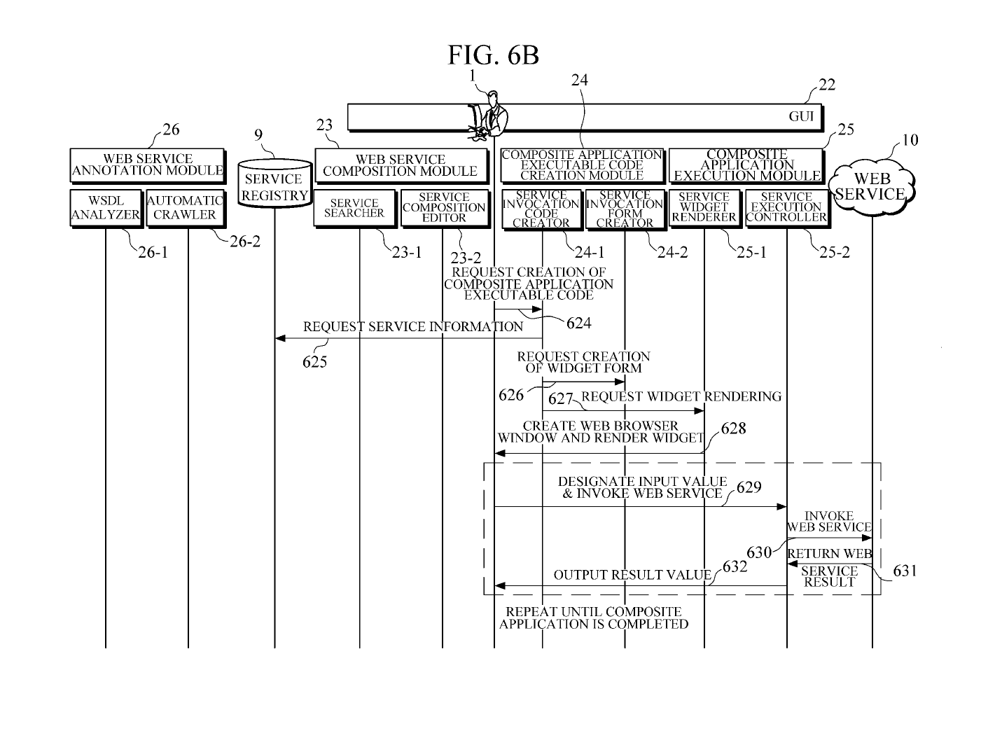

FIGS. 6A and 6B are flowcharts illustrating in detail the method of providing the development environment of the heterogeneous web service composite application according to an embodiment of the present invention.

FIG. 6 illustrates operations 619 to 631 in which the developer 1 searches and combines web services with the GUI 22 for composing and executing services, and creates an executable code of a composite application, and advance preparation operations 616 to 618 that extract meta information from web services installed in a remote or local server, and stores the meta information.

First, the automatic crawler 26-2 of the web service annotation module 26 crawls a webpage of a corresponding service for extracting meta information of web services in operation 616, and extracts the meta information from a web service specification and additional information. At this point, when the WSDL has been obtained, the automatic crawler 26-2 transfers the WSDL to the WSDL analyzer 26-1 and requests the analysis of the WSDL in operation 617. The WSDL analyzer 26-1 extracts meta information by analyzing the WSDL, and stores the extracted meta information in the service registry 9 in operation 618. The above-described annotation process may operate periodically and continuously update current information to new information.

The developer 1 views the service composition editor 23-2 of the web service composition module 23 with the GUI 22 in operation 619, and starts to combine services. In this case, the developer 1 searches web services one by one in operations 620 and 621, and then creates a service flow with the searched results in operations 622 and 623. These operations are repeated until a composite application is completed.

Subsequently, the developer 1 transfers the completed service flow of the composite application to the service invocation code creator 24-2 of the composite application executable code creation module 24, and requests the creation of an invocation code in operation 624. The service invocation code creator 24-2 requests meta information on a web service from the service registry 9 in operation 625, and creates an executable code. The service invocation code creator 24-2 requests the creation of a widget form, which will be represented on a web browser together with the executable code, from the service invocation form creator 24-2 in operation 626.

When the form that has been created according to the request is received, the service invocation code creator 24-2 requests the creation of a web browser window and the rendering of a widget from the service widget renderer 25-1 of the composite application executor 25 in operation 627. Then, the service widget renderer 25-1 creates the web browser window and performs the widget rendering in the created window in operation 628. When the widget is rendered for each web service that will be invoked by a web browser, the developer 1 may input an input value necessary for each web service to invoke a web service in operations 629 and 630. Subsequently, the developer 1 receives the invoked result from the web service in operation 631, and outputs the invoked result in operation 632.

The above-described operations 629 to 632 may be repeatedly performed for all web services configuring the composite application. When an output is not obtained before a predetermined timeout value is exceeded, the service execution controller 25-2 notifies the developer 1, who may click the ‘stop’ button 408 to forcibly end the invocation process. When invocation is normally performed and thus an output is obtained, the output is displayed in the result value window 409. The invocation of other web services may also be controlled by the above-described scheme with a widget.

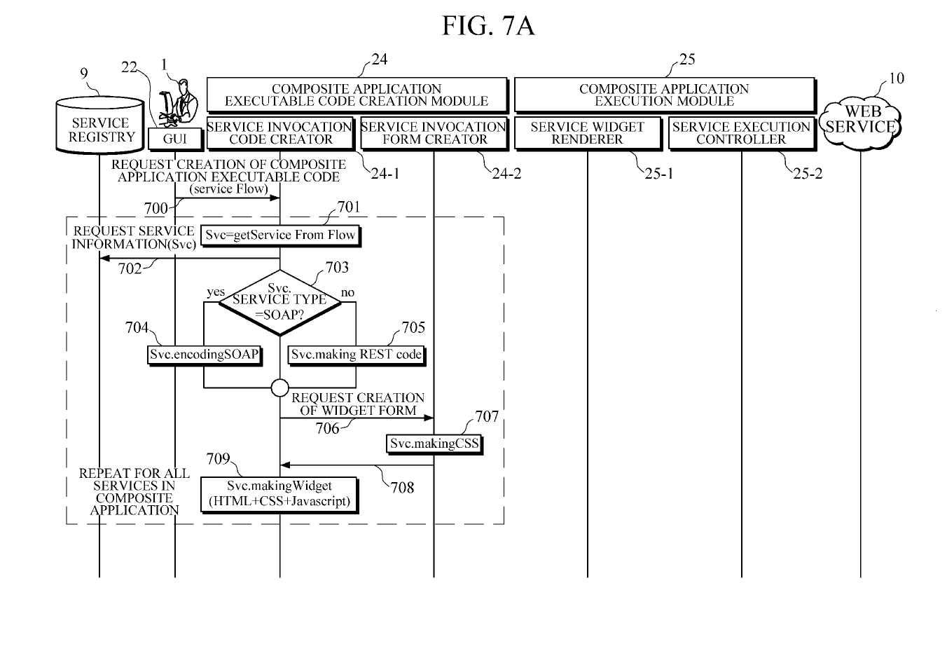

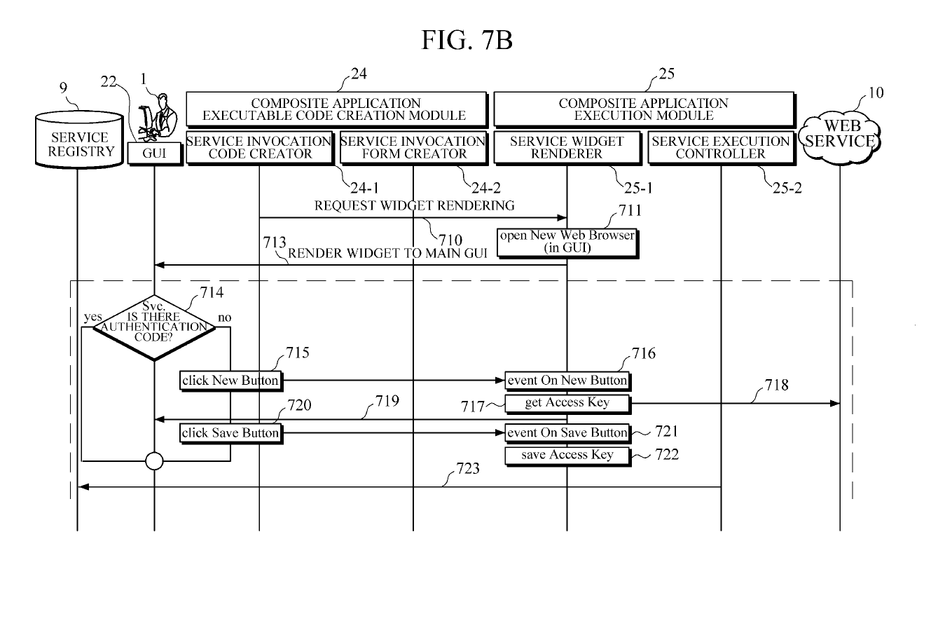

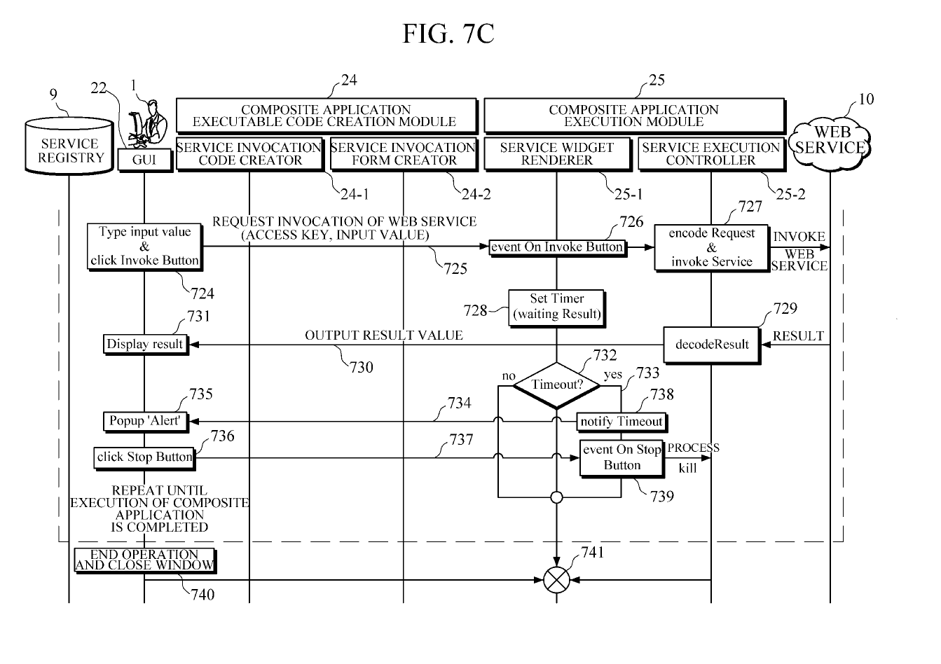

FIGS. 7A to 7C are flowcharts illustrating in detail a process of creating an executable code and executing a heterogeneous web service composite application according to an embodiment of the present invention.

In FIGS. 7A to 7C, specifically, a process (624 and 625) of automatically creating the executable code of FIG. 6B, and a process (626 to 632) in which the developer 1 personally invokes the executable code for executing a service, will be described in detail. When the developer 1 requests the creation of executable code of a composite application from the service invocation code creator 24-1 through operation 624 of FIG. 6B, a service flow that is a web service composition result is transferred to the service invocation code creator 24-1 in operation 700. The service invocation code creator 24-1 receiving the service flow obtains a web service from the service flow in operation 701. Furthermore, the service invocation creator 24-1 requests meta information on the obtained web service from the service registry 9, and obtains the meta information in operation 702. At this point, the service invocation creator 24-1 determines whether the type of a web service (Svc) is an SOAP web service or an HTTP-based RESTful web service, on the basis of the meta information in operation 703. When it is determined in operation 703 that the type of the web service is the SOAP web service, the service invocation creator 24-1 performs SOAP encoding in operation 704, and when it is determined in operation 703 that the type of the web service is the HTTP-based RESTful web service, the service invocation creator 24-1 performs HTTP encoding in operation 705, thereby creating a JavaScript for invoking a web service according to service types. When a web service invocation process is completed, the service invocation code creator 24-1 requests the creation of a code form from the service invocation form creator 24-2 in operation 706. Then, the service invocation form creator 24-2 creates a CSS in operation 707, and transfers the CSS to the service invocation code creator 24-1 in operation 708. The service invocation code creator 24-1 that has secured a web service invocation part (JavaScript) and a CSS form creates a widget in operation 709. That is, the service invocation code creator 24-1 creates a service widget by using an HTML code for processing the input/output of a web service, the JavaScript for invoking the web service, and the CSS for determining a form in operation 709. The above-described operations 701 to 709 are repeatedly performed for all web services configuring a composite application, and thus, a widget in which the HTML, the JaysScript, and the CSS have been combined is finally completed.

The service invocation code creator 24-1 that has completed the widget requests widget rendering on a web browser from the service widget renderer 25-1 in operation 710. Therefore, the service widget renderer 25-1 opens a new web browser in operation 711, refers to the service widget renderer 25-1 itself, and renders the widget on the web browser of the GUI 22 in operation 713.

The developer 1 performs subsequent operations for service authentication and invocation, in the widget rendered on the web browser. That is, the developer 1 checks whether there is an access code for a web service to invoke in operation 714. When there is no access code, the developer 1 clicks the ‘new’ button 403 (see FIG. 4), accesses a web service provider with the service widget renderer 25-1, and acquires a new access code in operations 716 to 719.

Subsequently, the developer 1 clicks the ‘save’ button 404 (see FIG. 4) in operation 720, and stores the newly-acquired access code in the service registry 9 with the service widget renderer 25-1 in operations 721 to 723. Therefore, when a corresponding web service is invoked later, the developer 1 reads the access code stored in the service registry 9 without newly acquiring another access code.

Subsequently, when the developer 1 inputs an input value necessary for invoking a web service and clicks the ‘invoke’ button 406 (see FIG. 4) in operation 724, the access code and the input value are transferred to the service widget renderer 25-1 in operation 725, and the service execution controller 25-2 encodes a web service invocation request according to invocation schemes of heterogeneous web services (for example, SOAP or RESTful web service) to execute an invocation code in operation 727, or receives a web service invocation result from a web service provider to decode the received invocation result in operation 729, whereupon the service widget renderer 25-1 outputs the decoded result value with the GUI 22. Also, the service widget renderer 25-1 has previously set a timeout value in operation 728, and when an invocation result is reached before timeout in operation 729, the service widget renderer 25-1 displays the invocation result in a result window in operations 730 and 731. However, when timeout occurs in operation 733, the service widget renderer 25-1 notifies the developer 1 in operations 734 to 736, and then the developer 1 clicks the ‘stop’ button 408 (see FIG. 4) in operations 737 and 738 to forcibly end the invocation process in operation 739. Furthermore, other web services may also control invocation with a widget in the above-described scheme. Execution for all web services included in the composite application may be repeated, and when the developer 1 closes a widget window, the function of the composite application execution module 25 is automatically ended in operation 741. Therefore, operations 701 to 709 of automatically creating a heterogeneous web service executable code, and operations 714 to 738 in which the developer 1 controls the execution of the composite application, may be performed.

According to the embodiments of the present invention, a web service composite application can be easily developed regardless of a device or a platform. That is, an application with web services composed therein can be developed and executed on a web browser usable in all Internet devices such as desktop computers, laptop computers, mobile phones, smart televisions (TVs), etc.

Moreover, meta information associated with web services to be composed is obtained in advance and stored in the service registry. By applying the stored meta information to an application composition and execution operation, the meta information can be used to automatically create and approve a service executable code.

Moreover, even though an application developer cannot recognize a heterogeneous web service type, an invocation method is automatically determined for each web service type and reflected in creating an executable code, thus increasing the automation level of a development environment.

Moreover, an application developer can personally treat an access code necessary for invocation in executing a service, thus increasing the convenience of a development environment.

As a result, an application developer combines heterogeneous web services irrespective of the kinds and characteristics of web services, and creates executable code of a composite application in real time, thus shortening an application development period. Also, although an application developer is not an expert skilled in programming languages or web services, the present invention enables the application developer to easily develop a web service composite application, thus reducing overall development costs in terms of an application development procedure, time, etc. Furthermore, a created executable code is executable on web browsers and thus the usability of an application can increase.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing a composite application development environment, the apparatus comprising:
an executable code creation module configured to create an executable code for executing the composite application; and
a composite application execution module configured to render the created executable code on a web browser to execute the composite application.

2. The apparatus of claim 1, wherein,
the executable code creation module creates an executable code of a composite application having a widget type, and
the widget creates an HTML code for processing an input and output of a web service, a CSS for determining a form, and a JavaScript for invoking each of heterogeneous web services.

3. The apparatus of claim 2, wherein the executable code creation module creates different JavaScript-based composite application executable codes per web service to be executable on the web browser irrespective of kinds of web services.

4. The apparatus of claim 1, wherein the executable code creation module comprises:
a service invocation code creator configured to create a JavaScript-based invocation code executable on the web browser according to invocation schemes of heterogeneous web services; and
a service invocation form creator configured to create a widget form that can be rendered on the web browser.

5. The apparatus of claim 4, wherein the service invocation code creator obtains meta information for each of web services configuring a flow of the web services which is a web service composition result, performs encoding for each of web service types to create a JavaScript for each web service type on the basis of the obtained meta information, requests creation of a CSS from the service invocation form creator and receives the CSS from the service invocation form creator, and creates a widget by using the JavaScript and the CSS.

6. The apparatus of claim 1, wherein the composite application execution module comprises:
a service widget renderer configured to render a widget on the web browser, and provide an access code acquisition function, a web service invocation function, and an invocation cancelation function, for invoking a service; and
a service execution controller configured to encode a web service invocation request and decode a web service invocation result according to invocation schemes of heterogeneous web services.

7. A method for providing a composite application development environment, the method comprising:
searching and composing multiple web services configuring a composite application;
creating an executable code for executing the composite application; and
rendering the created executable code on a web browser to execute the composite application.

8. The method of claim 7, wherein,
the creating of the executable code comprises creating executable code of a composite application having a widget type, and
the widget is configured with an HTML code for processing an input and output of a web service, a CSS for determining a form, and a JavaScript for invoking each of heterogeneous web services.

9. The method of claim 8, wherein the creating of the executable code comprises creating different JavaScript-based composite application executable codes per web service to be executable on the web browser irrespective of kinds of web services.

10. A method for providing a composite application development environment, the method comprising:
providing a JavaScript-based widget for each of the web services using a web browser for invoking a web service, after searching and editing the web services; and
providing a user interface for executing the composite application on the web browser with the provided widget, the user interface comprising an access code acquisition function, a web service invocation function, and an invocation cancelation function.

11. The method of claim 10, wherein the providing of the user interface comprises:
automatically displaying an access code when the application developer has previously obtained the access code, or accessing a webpage of a corresponding web service provider to obtain an access code with an access code acquisition interface when the application developer has not previously obtained the access code; and
storing the obtained access code in a service registry and, when a corresponding web service is invoked later, reading the access code stored in the service registry without the application developer obtaining a new access code.
